(19) United States
(12) Patent Application Publication
(10) Pub. No.: US 2015/0257341 A1
(43) Pub. Date: Sep. 17, 2015

(54) SYSTEM FOR PROTECTING A GROWING CONTAINER

(71) Applicant: Nursery Supplies, Inc., Chambersburg, PA (US)

(72) Inventors: Mark R. Alt, Carlisle, PA (US); Michelle R. Boudreau, Chambersburg, PA (US); Robert G. Summers, London, OH (US)

(73) Assignee: Nursery Supplies, Inc., Chambersburg, PA (US)

(21) Appl. No.: 14/644,877

(22) Filed: Mar. 11, 2015

Related U.S. Application Data
(60) Provisional application No. 61/952,519, filed on Mar. 13, 2014.

(51) Int. Cl. A01G 9/00; A01G 13/02

(52) U.S. Cl. CPC A01G 9/006; A01G 13/02

(57) ABSTRACT

A removal sleeve for protecting an external face of a growing container for nursery products, the container having an open top, a bottom and a side wall connecting the top to the bottom. The sleeve is formed from at least one sheet of polymer material and has a tubular, preferably cylindrical shape with upper and lower open ends. The sleeve configured to cover a majority of the side wall of the container between the top and bottom. The sleeve may be tapered and could be stretchable or shrinkable to fit onto the container. The sleeve is at least partially opaque, transparent or translucent. A UV additive or UV blocker may be added to the polymer or disposed on the sleeve to assist in minimizing passage of UV light to the underlying container.

### RELATED APPLICATION

The present application claims priority to U.S. Provisional Application 61/952,519, filed Mar. 13, 2014, the disclosure of which is incorporated herein by reference in its entirety.

### FIELD OF THE INVENTION

The present invention relates to a system for protecting a growing container and, more particularly to a sleeve configured to slip around the periphery of the growing container to protect it from the elements.

### BACKGROUND

During the growing of a plant, tree and other nursery product (hereinafter “plant”), a plant is placed in a nursery container and into the growing environment, which for large plants like bushes and trees is located outdoors, in an unprotected environment, typically directly on the ground. Many nursery growers and/or brand owners like to include advertising on their containers in order for customers to remember the brand of product they purchased. The problem has been that as the product sits outside during growing seasons, which can be as long as three or four years or more, the outside surface of the nursery container is prone to damage and degradation from exposure to the natural elements (UV radiation, rain, wind), exposure to chemicals within the watering system and exposure to the muck from the ground around the pot that splatters and then adheres onto the outside surface of the container. These events can cause damage and severely reduce the quality of the appearance of the container, including any logos and other brand advertising on the container.

In order to provide a clean container for shipment to retailers, the growers have a number of options which include but not limited to: (1) use of separate growing containers and then transplant the product from the growing container into a selling container, and (2) wash the outside surface of the container to remove the muck (does not correct any degradation to the brand logo or pot substrate). This is very costly, time consuming and detrimental to the environment.

### SUMMARY OF THE INVENTION

A removal sleeve for protecting an external face of a growing container for nursery products, the container having an open top, a bottom and a side wall connecting the top to the bottom. The sleeve is formed from at least one sheet of polymer material and has a tubular shape with upper and lower open ends. The sleeve is sized to cover a majority of the side wall of the container between the top and bottom. The sleeve is preferably cylindrical with a slight taper from the upper end to the lower end.

The polymer material preferably has elastic properties that permit the sleeve to stretch or shrink from its tubular shape. A chemical additive may be included in the polymer material or a coating may be applied to the sheet to minimize the passage of UV light to the underlying container.

The sleeve is preferably at least partially opaque, transparent or translucent.

The removable sleeve is sized so as to have an internal diameter sized to fit onto the container.

An adhesive, such as a removable pressure sensitive adhesive, may be added to an inside surface of the tubular sheet to assist in retaining the sleeve on the container.

The sleeve preferably includes graphical indicia, such as alphanumeric characters forming written instructions on the outside of the sheet.

A pull tab may be formed on the sheet and extend outward from an outer surface of the sheet to assist in removal of the sleeve from the container.

The sleeve may include at least one perforated seam extending along a portion of the sheet to allow the sleeve to be easily torn off the container without need for any sharp object. If the tab is included on the sheet, the tab may be located proximate the seam to facilitate the tearing of the perforations.

The sheet may be formed from a flat sheet with two side edges, the side edges being wrapped over one another and bonded or welded to form the tubular shape.

It is to be understood that both the foregoing general description and the following detailed description are exemplary and explanatory and are intended to provide further explanation of the invention as claimed.

### BRIEF DESCRIPTION OF THE FIGURES

For the purpose of the illustrating the invention, the drawings show a form of the invention which is presently preferred. However, it should be understood that this invention is not limited to the precise arrangements and instrumentalities shown in the drawings.

FIG. 1 is a perspective illustration of a protective sleeve for a nursery container according to the present invention.

FIG. 2 is a perspective illustration of a nursery container with a logo or other container marking with the protective sleeve of FIG. 1 arranged for attachment.

FIG. 3 is a perspective illustration of the nursery container of FIG. 2 with the protective sleeve on the container.

FIG. 4 is a perspective illustration of the protective sleeve of FIG. 1 illustrating a pull tab and perforated seam for ease in removal.

### BRIEF DESCRIPTION OF THE INVENTION

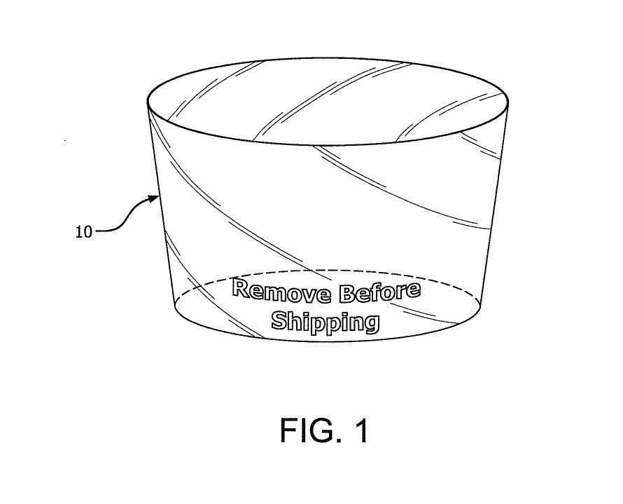

Referring to the figures, the present invention provides a protective sleeve and system for protecting a growing container. The sleeve 10 is shown in FIG. 1. The sleeve 10 is preferably cylindrical or tapered in shape, with upper and lower open ends. The sleeve 10 is preferably made from a polymer (plastic) material that permits the sleeve to (1) stretch slightly from its initial shape or (2) shrink from its original shape. The material for either type of sleeve can be opaque, transparent or translucent. In one embodiment, the material is a polyethylene based material with a thickness between about 0.001 inches and about 0.010 inches. As will become more apparent below, a transparent or translucent material allows for the grower to see the markings that are on the container to which the sleeve is applied. A colored sleeve could be used when greater UV protection is required and identifying the container brand is not required.

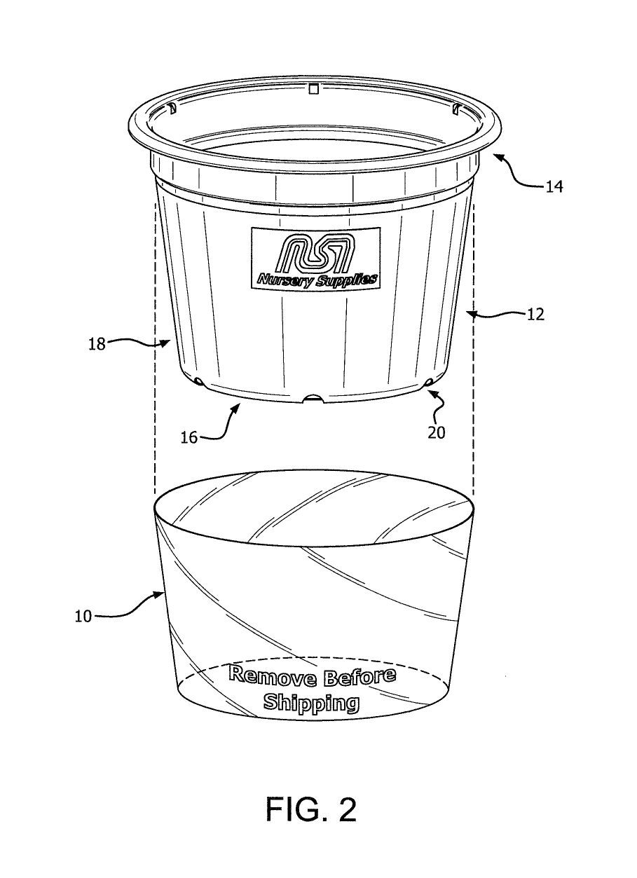

Referring to FIG. 2, the sleeve 10 is sized to fit (either by stretching or subsequent shrinking) onto a container 12. The container 12 includes an upper rim or lip 14 and a bottom 16. A side wall 18 connects the rim and bottom. The side wall 18 may include contours, such as indentations. The bottom includes one or more drainage openings 20. The container 12 is a conventional plastic nursery container made through any known manufacturing method, including injection molding, blow molding, rotomolding or thermoforming. Nursery Supplies, Inc., Chambersburg, Pa., the assignee of the instant invention, manufactures a number of different size containers that would be suitable for use with the sleeve 10.

The sleeve 10 has an opening at least at its upper end. For the version of the sleeve that stretches, the opening may be the same size or slightly smaller than the diameter of the container 12 near the upper portion of the sidewall, below the rim. Since most nursery containers have tapered sidewalls, the sleeve 10 could be formed with a slight taper. However, if the sleeve 10 is formed from material that stretches, the sizing could be selected such that the bottom opening of the sleeve is the same size in diameter of the container 12 at or near the bottom 16, and the top of the sleeve 10 would then stretch to secure the sleeve onto the container just below the rim. For the version of the sleeve that shrink-fits onto the container, the sleeve preferably would be slightly larger than the diameter of the container 12 near the upper portion of the sidewall, below the rim. For either style of sleeve it may be necessary to include an adhesive either on the back of the sleeve or between the sleeve and the container side wall to retain the sleeve on the container or prevent moisture from penetrating behind the sleeve. The adhesive would preferably be a conventional removable adhesive and may be applied on the inside of the sleeve along a portion of the sleeve or over the entire sleeve.

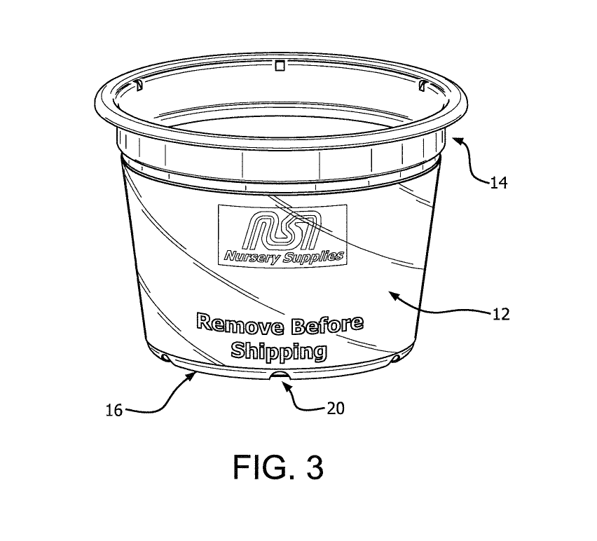

As shown in FIG. 3, once the sleeve 10 is slipped onto the container 10, it preferably covers the majority of the side wall 18 between the bottom 16 and the rim 14, including any markings. The sleeve 10 is preferably sized so that it does not completely cover the openings 20 on the bottom 16 since doing so could prevent proper drainage.

Referring to FIG. 3, an embodiment of the sleeve is shown which is made in a translucent color or shading, so as to permit viewing of any markings underneath (such as the container manufacturer, the product name or pricing bar codes. This permits a grower to easily recognize the product inside the container by the underneath markings. As mentioned above, the sleeve could be colored (opaque or translucent) to permit the grower to recognize the product just by visual inspection of the sleeve, without need to view the underling markings. For example red sleeves may be used on containers that include cherry trees and blue sleeves may be used on containers that contain apple trees.

The sleeve 10 might also include markings, such as written instructions, for example “Remove before shipping”, date information, customer details, growing instructions, etc.

The sleeve preferably contains a UV additive or UV blocker. The UV additive/blocker is intended to block or reduce the degrading effects of UV radiation which tend to cause brand markings and container coloring to fade, as well as degrade the pot substrate prematurely. There are a number of chemical additives on the market which can be added to plastic to provide UV protection, such as Ultimate UV sold by ColorMatrix Corporation, Berea, Ohio. Accordingly, no further discussion is needed. The UV blocker could be added to the polymer during the formation of the sleeve, or could be a coating that is applied to the sheet material. Also, as mentioned above, the sleeve could be formed with coloring (or have a coloring applied) which by its very nature could inhibit or minimize UV light passing to the container surface.

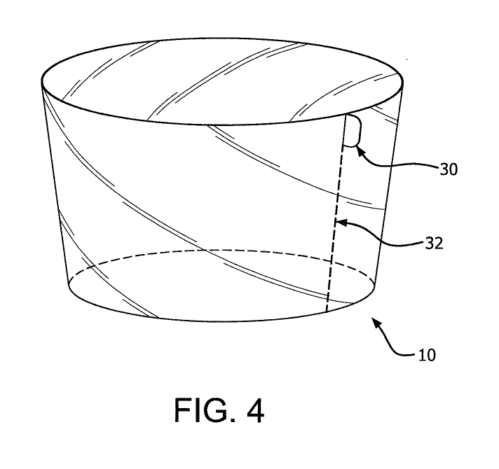

The sleeve is preferably designed to be removal. For example, after the growing is complete at a nursery, the sleeve 10 can be removed prior to shipment of the container 12 to its customer (such as a box store), thereby providing a cleaner, higher quality container, which greatly increases the salability of the product. The sleeve can be removed through the use of any sharp object. The sleeve can also be manufactured with a “pull tab” 30 with a perforated seam 32 to allow the sleeve to be removed without the use of a sharp object (see FIG. 4). It is also contemplated that the sleeve 10 could be used by retailers as a way to provide higher quality branding of the containers. That is, the sleeve 10 could include the retailer's name, plant type, growing instructions, etc., and be added onto the container 12 when it is received by the retailer. The end user can then easily remove it after it is purchased. This also allows for the container 12 to include markings that are only visible to the end user after purchase and when the end user takes off the sleeve. Alternatively, if the sleeve is opaque, it can include markings on both sides.

The sheet may be formed from a flat sheet of material that is cut to a desired size with two side edges. To form the tubular shape, one side edge is wrapped over the other and they are attached. They can be attached through any conventional means such as bonding (with adhesive) or heat welding. It is also contemplated that the sleeve may be extruded in a tubular form. Those skilled in the art would readily understand the different mechanisms and processes that can be used to form the claimed sleeve.

As mentioned above, the sleeve may be configured to shrink fit onto the container surface. This can be accomplished by sliding a sleeve that has a diameter that is slightly larger than the container onto the exterior of the container. A heat source is then applied to the sleeve causing it to shrink slightly onto the container surface.

In use, a sleeve of appropriate size and features (coloring, etc.) is selected. The sleeve is expanded or opened and placed on the outer surface of the container. The container is then filled with growing material (dirt, mulch, etc.) and the nursery item (plant, tree, bush, etc.) that is being grown. Once the nursery item has matured, the sleeve may be removed, such as pulling on a tab if one is present. The removal could be performed prior to shipment to a distributor or a public nursery, or it could be removed once it is received at the distributor/nursery.

Although the present invention has been described and illustrated with respect to the exemplary embodiments thereof, it should be understood by those skilled in the art that the foregoing and various other changes, omissions and additions may be made therein and thereto, without parting form the spirit and scope of the present invention.

1. A removal sleeve for protecting an external face of a growing container for nursery products, the container having an open top, a bottom and a side wall connecting the top to the bottom, the sleeve comprising at least one sheet of polymer material that has a tubular shape with upper and lower open ends, the sleeve configured to cover a majority of the side wall of the container between the top and bottom.

2. The removable sleeve for a nursery container according to claim 1, wherein the tubular shape is cylindrical.

3. The removable sleeve for a nursery container according to claim 2, wherein the cylindrical shape is tapered from the upper end to the lower end.

4. The removable sleeve for a nursery container according to claim 1, wherein the polymer material has elastic properties that permit the sleeve to stretch or shrink from its tubular shape.

5. The removable sleeve for a nursery container according to claim 1, wherein the sleeve is at least partially opaque, transparent or translucent.

6. The removable sleeve for a nursery container according to claim 1, wherein the sleeve includes a feature that reduces passage of UV light to the underlying container during use to reduce the degrading effects of UV radiation.

7. The removable sleeve for a nursery container according to claim 6, wherein the feature is a UV additive or UV blocker.

8. The removable sleeve for a nursery container according to claim 1, wherein the sleeve is sized so as to have an internal diameter sized to fit onto the container.

9. The removable sleeve for a nursery container according to claim 1, wherein the sleeve has an adhesive on an inside surface of the tubular shape for assisting in retaining the sleeve on the container.

10. The removable sleeve for a nursery container according to claim 9, wherein the adhesive is a removable pressure sensitive adhesive.

11. The removable sleeve for a nursery container according to claim 1, wherein the sleeve includes graphical indicia.

12. The removable sleeve for a nursery container according to claim 11, wherein the graphical indicia is alphanumeric characters forming written instructions.

13. The removable sleeve for a nursery container according to claim 1, wherein the sleeve includes a pull tab extending outward from the sheet to assist in removal of the sleeve from the container.

14. The removable sleeve for a nursery container according to claim 1, wherein the sleeve includes at least one perforated seam extending along a portion of the sheet to allow the sleeve to be easily torn off the container without need for any sharp object.

15. The removable sleeve for a nursery container according to claim 1, wherein the sheet is formed from a flat sheet with two side edges, the side edges being wrapped over one another and bonded or welded to form the tubular shape.

16. A removal sleeve for protecting an external face of a growing container for nursery products, the container having an open top, a bottom and a side wall connecting the top to the bottom, the sleeve comprising at least one sheet of polymer material that has a cylindrical shape with upper and lower open ends, the sleeve configured to cover a majority of the side wall of the container between the top and bottom, the sleeve including a chemical for inhibiting passage of UV light through the sleeve.

17. The removable sleeve for a nursery container according to claim 16, wherein the sleeve includes graphical indicia.

18. The removable sleeve for a nursery container according to claim 17, wherein the sleeve includes a pull tab extending outward from the sheet to assist in removal of the sleeve from the container, and at least one perforated seam extending along a portion of the sheet to the pull tab to permit easy tearing of the sleeve for removal.
